(19) United States
(12) Patent Application Publication
(10) Pub. No.: US 2007/0207689 A1
(43) Pub. Date: Sep. 6, 2007

(54) Temperature regulating ballistic material

(76) Inventors: James Dale Taylor, Coral Springs, FL (US); Eric D. Ritter, Monmouth, ME (US); Stan Edward Farrell, Manchester, ME (US); David F. Erb JR., Readfield, ME (US)

Correspondence Address: HOLLAND & KNIGHT LLP, 10 ST. JAMES AVENUE, 11th Floor, BOSTON, MA, 02116-3889, US

(21) Appl. No.: 11/367,216

(22) Filed: Mar. 3, 2006

(51) Int. Cl. B32B 27/12; B32B 27/04; B32B 5/14; B32B 5/02

(52) U.S. Cl. 442/135; 428/310.5; 442/134; 428/911

(57) ABSTRACT

In an aspect, the invention features a ballistic-resistant panel including at least one layer of ballistic material having a phase change material disposed thereon and an outer cover having inner surface that forms a pocket and an outer surface having an inner face and an outer face. The ballistic material has an inner surface and an outer surface and is disposed within the pocket of the outer cover with the ballistic material inner surface adjacent to the outer cover inner face.

### FILED OF INVENTION

The present invention relates to ballistic materials, and more specifically temperature regulating ballistic materials.

### BACKGROUND

Conventional bullet-resistant garments, such as bullet-resistant vests, tend to cause the user to become hot, perspire and potentially overheat, especially during strenuous activities or hot days. Most bullet-resistant garments are designed to be worn by law enforcement or military personnel, who are often involved in strenuous activities, such as foot pursuits, patrolling or being involved in a firefight. However, because the bullet-resistant garments are often too hot, many users do not regularly wear the protective garment, thereby increasing the risk of injury due to ballistic threats (e.g., bullets or shrapnel). The present invention helps overcomes these limitations.

### SUMMARY

The present invention provides ballistic materials that include phase change materials to help regulate the body temperature of a wearer of garments including ballistic material. The phase change material disposed on the ballistic material regulates the temperature of the wearer by absorbing heat from the wearer when the wearer is hot and giving the heat back to the wearer when the wearer cools down.

In general, in one aspect, the invention features a ballistic-resistant panel having at least one layer of ballistic material with a ballistic material inner surface and a ballistic material outer surface, a phase change material disposed on the ballistic material, and an outer cover. The outer cover has an outer cover inner surface and an outer cover outer surface, where the inner surface forms a pocket, and an inner face and an outer face, where the inner face is adjacent to a user when worn. The ballistic material is disposed within the pocket of the outer cover with the ballistic material inner surface adjacent to the outer cover inner face.

In embodiments, each layer of ballistic material comprises more than one ballistic ply to each other. In certain embodiments, each of the ballistic plies include phase change material disposed thereon. In other embodiments, less than all of the ballistic plies include phase change material disposed thereon. In embodiments, less than all of the ballistic plies include phase change material disposed thereon and the phase change material is disposed on the ballistic plies closest to the ballistic material inner surface.

In embodiments, all layers of ballistic material include phase change material disposed thereon. In other embodiments, less than all layers of ballistic material include phase change material disposed thereon. In embodiments, the ballistic material may be aramid, para-aramid, polypropylene, polyethylene, poly (p-phenylene-2,6-benzobisoxazole), polyester, nylon, liquid crystal polymers or any combination thereof.

In embodiments, the ballistic-resistant panel includes a first layer of ballistic material made of a first ballistic material adjacent to the outer cover inner face, the first layer having at least one ply, and a second layer of ballistic material made of a second ballistic material adjacent to the outer cover outer face, the second layer having at least one ply, the two layers being adjacent to each other. In certain embodiments, the phase change material is disposed on the first layer. In embodiments, the first layer is woven plies, the second layer is non-woven plies, and the phase change material is disposed on the second layer of non-woven plies. In embodiments, the first layer and second layer are mechanically connected by portions of the non-woven plies which extend into the woven plies, perpendicular to the woven plies.

In embodiments, the ballistic-resistant panel also includes a first layer of ballistic material made of a first ballistic material adjacent to the outer cover inner face, the first layer having at least one ply, a second layer of ballistic material made of a second ballistic material adjacent to the outer cover outer face, the second layer having at least one ply, and a third layer of ballistic material made of a third ballistic material, the third layer having at least one ply, where the third layer is disposed between the first and second layers. In certain embodiments, the first ballistic material and the second ballistic material are the same ballistic material. In embodiments, the first ballistic material, second ballistic material and third ballistic material may be aramid, para-aramid, polypropylene, polyethylene, poly (p-phenylene-2,6-benzobisoxazole), polyester, nylon, liquid crystal polymers or any combination thereof.

In embodiments, the first layer and second layer are woven plies, the third layer is non-woven plies, and the phase change material is disposed on the third layer of non-woven plies. In embodiments, the first layer and third layer are mechanically connected by portions of the non-woven plies which extend into the woven plies perpendicular to the woven plies.

In embodiments, the phase change material may be paraffin compounds, such as paraffinic hydrocarbons, salt hydrides, fatty acids, esters, inorganic salts, or eutectic compounds. In embodiments, the outer cover also includes phase change material.

In general, in another aspect, the invention features a bullet-resistant garment including an armor carrier having a contact surface, which is adjacent to a user when worn, and a retaining compartment and a ballistic panel disposed within the retaining compartment. The ballistic panel includes a first layer of ballistic material made of multiple plies of a first ballistic material, a second layer of ballistic material made of multiple plies of a second ballistic material, a third layer of ballistic material made of multiple plies of a third ballistic material, where the third layer is disposed between the first and second layers forming a ballistic unit, a phase change material disposed on at least one layer of ballistic material, and an outer cover including an outer cover inner surface and an outer cover outer surface, the inner surface forming a pocket, the cover also including an inner face and an outer face. The ballistic unit is disposed within the pocket of the outer cover with the first layer adjacent to the outer cover inner face and the second layer adjacent to the outer cover outer face. The outer cover inner face is adjacent to the contact surface when disposed in the retaining pocket of the armor carrier.

In embodiments, the phase change material may be paraffin compounds, such as paraffinic hydrocarbons, salt hydrides, fatty acids, esters, inorganic salts, or eutectic compounds. In embodiments, the first ballistic material, second ballistic material and third ballistic material may be aramid, para-aramid, polypropylene, polyethylene, poly (p-phenylene-2,6-benzobisoxazole), polyester, nylon, liquid crystal polymers or any combination thereof.

In embodiments, the first ballistic material and second ballistic material are the same. In other embodiments, the first ballistic material and second ballistic material are woven fabrics and the third ballistic material is a non-woven material with the phase change material disposed thereon, whereby at least the first layer of ballistic material and third layer of ballistic material are mechanically connected by portions of the non-woven third layer which extend into the first layer perpendicular to the woven fabric.

In embodiments, the outer covering also includes phase change material. In certain embodiments, the contact surface of the armor carrier also has a wicking material and a vapor barrier between the wicking material and the outer cover of the ballistic panel. In other embodiments, the contact surface of the armor carrier includes a wicking material and the outer cover of the ballistic panel includes a vapor barrier. In embodiments, the outer cover also includes an inner layer having phase change material.

In general, in another aspect, the invention features a method for making a ballistic panel including stacking multiple plies of a first ballistic material together to make a first layer, stacking multiple plies of a second ballistic material together to make a second layer, and stacking multiple plies of a third ballistic material together to form a third layer. The first layer, second layer and third layers are stacked adjacent to each other with the third layer disposed between the first and second layers to make a ballistic unit. A phase change material is disposed on at least one layer of the ballistic material. The ballistic unit is placed within a pocket formed in an outer cover, the outer cover having an outer cover inner face and outer cover outer face, the first layer being adjacent to the outer cover inner face and the second layer being adjacent to the outer cover outer face.

In embodiments, disposing the phase change material on the ballistic material is performed while the ballistic material is being made. In other embodiments, disposing the phase change material on the ballistic material is performed prior to the plies being cut. In other embodiments, disposing the phase change material on the ballistic material is performed after the plies are cut. In still other embodiments, disposing the phase change material on the ballistic material is performed after the layers are formed. In other embodiments, disposing the phase change material on the ballistic material is performed after the layers are stacked.

In embodiments, the phase change material may be paraffin compounds, such as paraffinic hydrocarbons, salt hydrides, fatty acids, esters, inorganic salts, or eutectic compounds. In embodiments, the first ballistic material, second ballistic material and third ballistic material may be aramid, para-aramid, polypropylene, polyethylene, poly (p-phenylene-2,6-benzobisoxazole), polyester, nylon, liquid crystal polymers or any combination thereof. In embodiments, the first ballistic material and second ballistic material are the same.

In embodiments, the first ballistic material and second ballistic material are woven fabrics, the third ballistic material is a non-woven material, and the phase change material is disposed on the non-woven material. The first layer and third layer are mechanically connected by needle felting the ballistic unit, thereby pulling portions of the non-woven third layer into the woven first layer perpendicular to the woven fabric and entangling the two layers.

The invention can be implemented to realize one or more of the following advantages. Incorporating phase change materials directly into the ballistic fabric eliminates the need to include bulky insert cooling packs, which are often fitted into pockets within the bullet-resistant garment. This enables the entire ballistic garment to become a temperature regulating device, thereby eliminating smaller cooling spots concentrated only at the places where pockets can be added to the garment. Further, the phase change materials within the ballistic fabric allows for a thinner and lighter garment, thereby resulting in a more comfortable garment to wear. Also, the cooling effect of the ballistic panel can be made to be closer to the user's body, thereby increasing the cooling effect. Further still, the use of phase change materials enables the heat generated by the user to be transferred back to the user after the strenuous activity ends and the user's body temperature starts to cool.

Other features and advantages of the invention are apparent from the following description, and from the claims.

### BRIEF DESCRIPTION OF THE DRAWINGS

FIG. 1 is a partial cut-away view of an exemplary ballistic panel according to one embodiment of the invention.

FIG. 2 is a cross-section of the ballistic panel of FIG. 1.

FIG. 3 is a partial cut-away perspective view of an exemplary armor carrier containing the ballistic panel of FIG. 1.

Like reference numbers and designations in the various drawings indicate like elements.

### DETAILED DESCRIPTION

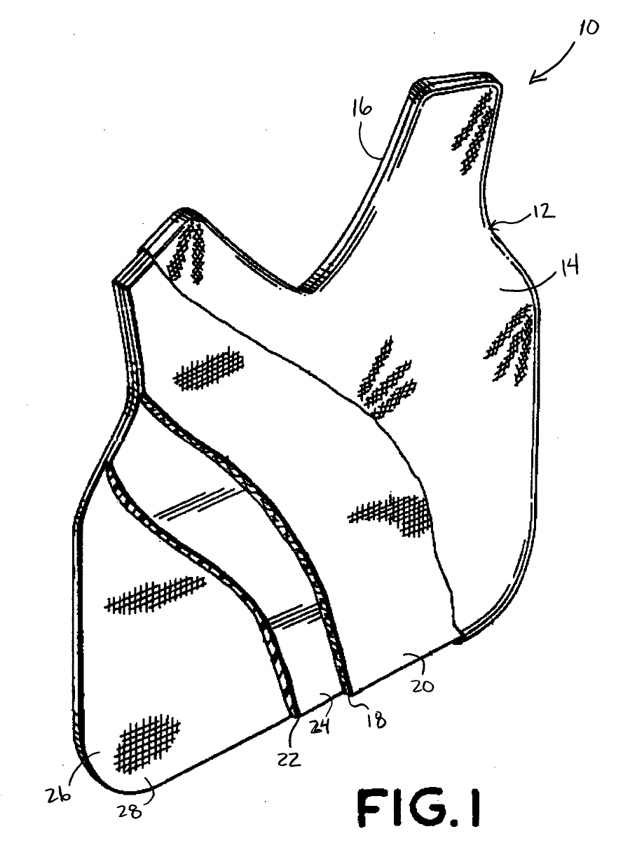

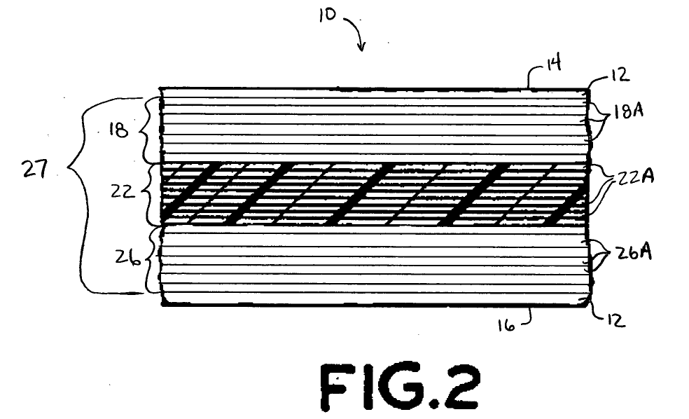

Referring to FIGS. 1 and 2, a ballistic panel 10 includes an outer covering 12. The outer covering 12 has an inner face 14 positioned towards a user, and usually in contact with the user, when worn and an outer face 16 positioned away from the user when worn. The outer covering 12 is configured to contain ballistic material and may be made from any suitable material.

The ballistic material may include several layers of varying material. For example, the ballistic material may include plies 18A and 26A made from a first material and plies 22A made from a second material. For example, the first material may be aramid and the second material may be polyethylene (or vice versa), but any suitable ballistic material may be used. The plies 18A, 22A and 26A are grouped into layers 18, 22 and 26 and laid adjacent to each other to form a ballistic unit 27. Depending on the desired amount of protection to be supplied by the ballistic panel 10, different numbers of plies 18A, 22A and 26A are used to form the ballistic unit 27. Each layer 18, 22 and 26 has an inner surface 20, 24 and 28 respectively that is positioned towards the user when worn.

To improve thermal comfort of a ballistic garment, the ballistic unit 27 includes a phase change material. Phase change materials referred to herein are substances that change phase (i.e., solid to liquid or liquid to solid) within a temperature range around average skin temperature. An exemplary phase change material would tend to stabilize into a slush state of half liquid and half solid just below a comfortable skin temperature at rest. Then, as an activity level of the user increases, the slush absorbs the excess heat generated by the user, keeping the body cooler and extending the time before the user begins to perspire. For example, if a law enforcement officer wearing a bullet-resistant vest containing phase change material is chasing a suspect on foot on a cold winter day, the strenuous activity of running would cause the officer's skin temperature to rise. The phase change material within the bullet-resistant vest absorbs the heat and shifts towards a liquid, rather than reflecting the heat back towards the skin, helping the officer maintain a more comfortable body temperature and not overheat. After the officer stopped running and was standing in the cold surrounding temperature, the phase change material returns the heat to the officer, and returns towards a solid, so that the officer does not become cold. The phase change material acts as a thermal shock absorber by slowing or minimizing the rate of temperature change within the user's clothing or microclimate. By applying phase change materials to the ballistic material, the ballistic panel 10 becomes a temperature regulating device.

The phase change material can be infused into the ballistic material in several ways. In one example, layer 18 is made from para-aramid fibers, such as Kevlar® from DuPont, that is infused with a micro-encapsulated phase change material, such as paraffin compounds sold by Outlast Technologies, Inc., of Boulder, Col., under the trade name Thermocules®. In other examples, the phase change material may be bulk, micro-encapsulated or macro-encapsulated. In still other examples, the phase change material may be paraffin compounds, such as paraffinic hydrocarbons, salt hydrides, fatty acids, esters, inorganic salts, or eutectic compounds. Phase change materials may be bonded to the aramid fibers during the manufacturing of the aramid fibers on a nanotechnology scale. The aramid fibers are then used to weave a ballistic fabric from which ply 18A is cut and incorporated into layer 18 of the ballistic panel 10. Preferably, each ply 18A of the layer 18 contains the phase change material. However, the layer 18 may be made with only certain plies 18A containing the phase change material. Since phase change materials tend to give the best cooling effect when located close to the skin, preferably the plies closest to inner face 20 contain the phase change material.

In another example of the ballistic panel 10, layer 22 includes non-woven plies 22A of ballistic material. The non-woven plies 22A may be aramid fibers, para-aramid fibers (e.g., Kevlar®, Artec® or Rusar®), polyethylene fibers, polypropylene fibers, poly (p-phenylene-2,6-benzobisoxazole) (“PBO”) fibers, polyester fibers, nylon fibers, liquid crystal polymer fibers or any other ballistic resistant material. Layers 18 and 26 may include plies 18A and 26A made of woven fabrics, such as para-aramid fibers (Kevlar®), PBO, high molecular weight polyethylene fibers or any woven ballistic resistant material. The phase change material is applied to the non-woven ballistic layer 22, either during the manufacture of the fibers or after the fibers are laid together to form the non-woven plies 22A.

The desired number of woven plies 18A and 26A and non-woven plies 22A are laid adjacent to each other to form layers 18, 22 and 26, with the non-woven layer 22 sandwiched between the woven layers 18 and 26, to form the ballistic unit 27. After the ballistic unit 27 is formed, the ballistic unit 27 is subjected to a needle felting process whereby needles are driven perpendicularly through the layers 18, 22 and 26 and catch on the non-woven fibers. As the needles are withdrawn, they pull the phase change infused non-woven fibers into and through the woven plies 18A and 26A. Since the phase change material tends to give the best cooling effect when located close to the skin, the non-woven fibers are preferably pulled through woven layer 18 towards inner surface 20. The needle felting process entangles the non-woven fibers into the woven layers substantially perpendicular to the x-y plane, which mechanically connects the various plies 18A and helps prevent the individual yams from separating during a ballistic impact. The needle felting processes also increases the density of the ballistic unit 27 by engaging more fibers per unit volume. Also, by needling a felt towards inner surface 20, the phase change material is brought closer to the user's body, providing a better cooling effect. By selectively needling a felt towards particular areas of the ballistic panel, it is possible to optimize cooling in areas that tend to overheat first, such as under a user's arms during strenuous activity or the lower back when seated in a vehicle on a hot day.

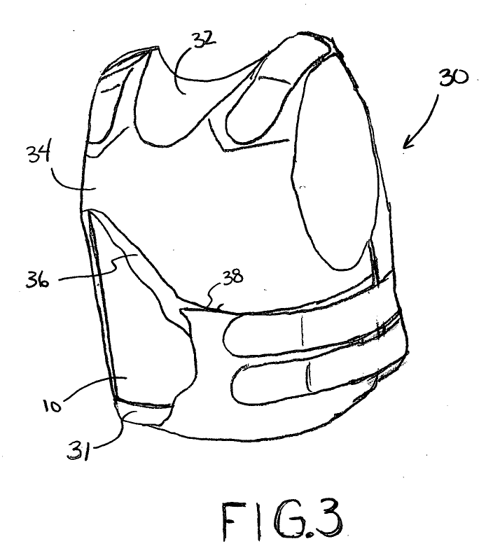

Referring to FIG. 3, the ballistic panel 10 is placed within a retaining compartment 31 in an armor carrier 30 through opening 38. The opening can be closed with a zipper, snaps, hook and loop fasteners or any other suitable fastener. The armor carrier 30 has a contact surface 32 which is adjacent to the user when worn and an outer surface 34 which faces away from the user. To enhance the temperature regulating effect of the phase change material within the ballistic panel 10, armor carrier 30 may include a moisture wicking material, either as a fabric within the armor carrier 30 or as a coating applied to the armor carrier 30 on at least the contact surface 32. Such moisture wicking material may enable enhanced cooling through evaporation by pulling perspiration away from the user. When a moisture wicking material is included within the armor carrier 30, a vapor barrier is recommended between the armor carrier 30 and the ballistic panel 10. The vapor barrier can be an additional layer 36 in the armor carrier 30 or the outer covering 12 of the ballistic panel 10.

It is to be understood that the foregoing description is intended to illustrate and not to limit the scope of the invention, which is defined by the scope of the appended claims. Other embodiments are within the scope of the following claims. For example, while the ballistic fibers disclosed above were described as being manufactured with phase change materials, the phase change material can be applied to the ballistic fibers at a secondary stage (i.e., applied to the spool of ballistic fibers before weaving into a ballistic fabric) or to the woven fabric before it is cut to size for the plies. Further, the phase change material can be applied to an individual ballistic ply or group of plies after being woven and cut. This may be accomplished by spraying the phase change material onto the individual plies, a layer of multiple plies or the ballistic unit before placing them into the outer covering 20, or dipping the individual plies, layers of multiple plies or the ballistic unit into phase change material before placing them into the outer covering 20.

Also, while the phase change material has been described as being on or within certain layers 18, 22 and 26 or various plies 18A, 22A and 26A within each layer, any and/or all the layers may contain phase change material. Further, the outer covering 12 may also include phase change materials. Further still, all layers and the outer covering (i.e, the entire ballistic panel 10 and outer covering 12) may contain phase change materials. Also, the outer cover 12 of the ballistic panel 10 may be made of two layers of material, an outer layer made of a material that acts as a vapor barrier and an inner layer that may contain a phase change material

Further, while the ballistic layers 18, 22 and 26 were described as being made from two different ballistic materials, each layer may be made from the same material or each layer may be made from different material (e.g., three layers using three different materials). Further still, the ballistic unit 27 could be made from more or less layers than described above (e.g., more than three layers), and each layer may be made from any suitable ballistic material.

Also, while the phase change material was described in a first example as being infused into the ballistic material, in another example the phase change material may be impregnated into a plastic film, such as polyethylene. The plastic film is then disposed on a ballistic layer 18,22 and/or 26 or the outer cover 12 by laminating the plastic film thereto. For example, a phase change impregnated plastic film may be disposed on layer 18 by laminating the plastic film to layer 18. Further, the phase change impregnated plastic film may be laminated between layers 18 and 22, thereby bonding the layers together.

While armor carrier 30 is shown as a vest, any configuration can be used, such as a shirt, pants or area-specific armor (head, arms, legs, knees, crotch, etc.).

What is claimed is:

1. A ballistic-resistant panel comprising:
at least one layer of ballistic material having a ballistic material inner surface and a ballistic material outer surface;
an outer cover including an outer cover inner surface and an outer cover outer surface, the inner surface forming a pocket, the outer cover also including an inner face and an outer face, the inner face being adjacent to a user when worn; and
a phase change material disposed on the ballistic material, the ballistic material being disposed within the pocket of the outer cover with the ballistic material inner surface adjacent to the outer cover inner face.

2. The ballistic-resistant panel of claim 1 wherein the at least one layer of ballistic material comprises more than one ballistic ply adjacent to each other.

3. The ballistic-resistant panel of claim 2 wherein each of the ballistic plies include phase change material disposed thereon.

4. The ballistic-resistant panel of claim 2 wherein less than all of the ballistic plies include phase change material disposed thereon.

5. The ballistic-resistant panel of claim 2 wherein less than all of the ballistic plies include phase change material disposed thereon, the phase change material being disposed on the ballistic plies closest to the ballistic material inner surface.

6. The ballistic-resistant panel of claim 1 wherein all layers of ballistic material include phase change material disposed thereon.

7. The ballistic-resistant panel of claim 1 wherein less than all layers of ballistic material include phase change material disposed thereon.

8. The ballistic-resistant panel of claim 1 wherein the ballistic material is selected from the group consisting of aramid, para-aramid, polypropylene, polyethylene, poly (p-phenylene-2,6-benzobisoxazole), polyester, nylon, liquid crystal polymers and any combination.

9. The ballistic-resistant panel of claim 1 further comprising:
a first layer of ballistic material made of a first ballistic material adjacent to the outer cover inner face, the first layer including at least one ply; and
a second layer of ballistic material made of a second ballistic material adjacent to the outer cover outer face, the second layer including at least one ply, wherein the two layers are adjacent to each other.

10. The ballistic-resistant panel of claim 9 wherein the phase change material is disposed on the first layer.

11. The bullet-resistant panel of claim 9 wherein the first layer comprises woven plies and the second layer comprises non-woven plies, the phase change material disposed on the second layer of non-woven plies.

12. The bullet-resistant panel of claim 11 wherein the first layer and second layer are mechanically connected by portions of the non-woven plies which extend into the woven plies perpendicular to the woven plies.

13. The ballistic-resistant panel of claim 1 further comprising
a first layer of ballistic material made of a first ballistic material adjacent to the outer cover inner face, the first layer including at least one ply;
a second layer of ballistic material made of a second ballistic material adjacent to the outer cover outer face, the second layer including at least one ply; and
a third layer of ballistic material made of a third ballistic material, the third layer including at least one ply, the third layer being disposed between the first and second layers.

14. The ballistic panel of claim 13 wherein the first ballistic material and the second ballistic material are the same ballistic material.

15. The ballistic panel of claim 13 wherein the first ballistic material, second ballistic material and third ballistic material are selected from the group consisting of aramid, para-aramid, polypropylene, polyethylene, poly (p-phenylene-2,6-benzobisoxazole), polyester, nylon, liquid crystal polymers and any combination thereof.

16. The ballistic panel of claim 13 wherein the first layer and second layer comprise woven plies and the third layer comprises non-woven plies, the phase change material disposed on the third layer of non-woven plies.

17. The ballistic-resistant panel of claim 16 wherein the first layer and third layer are mechanically connected by portions of the non-woven plies which extend into the woven plies perpendicular to the woven plies.

18. The ballistic-resistant panel of claim 1 where in the phase change material is selected from the group consisting of paraffin compounds, salt hydrides, fatty acids, esters, inorganic salts, and eutectic compounds.

19. The ballistic-resistant panel of claim 1 wherein the outer cover further comprises phase change material.

20. A bullet-resistant garment comprising:
an armor carrier including a contact surface which is adjacent to a user when worn and a retaining compartment; and
a ballistic panel disposed within the retaining compartment, the ballistic panel comprising:
a first layer of ballistic material made of multiple plies of a first ballistic material;
a second layer of ballistic material made of multiple plies of a second ballistic material;
a third layer of ballistic material made of multiple plies of a third ballistic material; the third layer being disposed between the first and second layers forming a ballistic unit;
a phase change material disposed on at least one layer of ballistic material; and
an outer cover including an outer cover inner surface and an outer cover outer surface, the inner surface forming a pocket, the cover also including an inner face and an outer face, the ballistic unit being disposed within the pocket of the outer cover with the first layer adjacent to the outer cover inner face and the second layer adjacent to the outer cover outer face, and the outer cover inner face being adjacent to the contact surface when disposed in the retaining pocket of the armor carrier.

21. The bullet-resistant garment of claim 20 wherein the phase change material is selected from the group consisting of paraffin compounds, salt hydrides, fatty acids, esters, inorganic salts, and eutectic compounds.

22. The bullet-resistant garment of claim 20 wherein the first ballistic material, second ballistic material and third ballistic material are selected from the group consisting of aramid, para-aramid, polypropylene, polyethylene, poly (p-phenylene-2,6-benzobisoxazole), polyester, nylon, liquid crystal polymers and any combination thereof.

23. The bullet-resistant garment of claim 22 wherein the first ballistic material and second ballistic material are the same.

24. The bullet-resistant garment of claim 20 wherein the first ballistic material and second ballistic material are woven fabrics and the third ballistic material is a non-woven material with the phase change material disposed thereon, whereby at least the first layer of ballistic material and third layer of ballistic material are mechanically connected by portions of the non-woven third layer which extend into the first layer perpendicular to the woven fabric.

25. The bullet-resistant garment of claim 20 wherein the outer covering further comprises phase change material.

26. The bullet-resistant garment of claim 20 wherein the contact surface of the armor carrier comprises a wicking material and the armor carrier further comprises a vapor barrier between the wicking material and the outer cover of the ballistic panel.

27. The bullet-resistant garment of claim 20 wherein the contact surface of the armor carrier comprises a wicking material and the outer cover of the ballistic panel comprises a vapor barrier.

28. The bullet-resistant garment of claim 27 wherein the outer cover further comprises an inner layer including phase change material.

29. A method for making a ballistic panel comprising:
stacking multiple plies of a first ballistic material together to make a first layer;
stacking multiple plies of a second ballistic material together to make a second layer;
stacking multiple plies of a third ballistic material together to form a third layer;
stacking the first layer, second layer and third layers adjacent to each other with the third layer disposed between the first and second layers to make a ballistic unit;
disposing a phase change material on at least one layer of ballistic material; and
placing the ballistic unit within a pocket formed in an outer cover, the outer cover including an outer cover inner face and outer cover outer face, the first layer being adjacent to the outer cover inner face and the second layer being adjacent to the outer cover outer face.

30. The method of claim 29 wherein disposing the phase change material on the ballistic material is performed while the ballistic material is being made.

31. The method of claim 29 wherein disposing the phase change material on the ballistic material is performed prior to the plies being cut.

32. The method of claim 29 wherein disposing the phase change material on the ballistic material is performed after the plies are cut.

33. The method of claim 29 wherein disposing the phase change material on the ballistic material is performed after the layers are formed.

34. The method of claim 29 wherein disposing the phase change material on the ballistic material is performed after the layers are stacked.

35. The method of claim 29 wherein the phase change material is selected from the group consisting of paraffin compounds, salt hydrides, fatty acids, esters, inorganic salts, or eutectic compounds.

36. The method of claim 29 wherein the first ballistic material, second ballistic material and third ballistic material are selected from the group consisting of aramid, para-aramid, polypropylene, polyethylene, poly (p-phenylene-2,6-benzobisoxazole), polyester, nylon, liquid crystal polymers and any combination thereof.

37. The method of claim 29 wherein the first ballistic material and second ballistic material are the same.

38. The method of claim 37 wherein
the first ballistic material and second ballistic material are woven fabrics;
the third ballistic material is a non-woven material; and
the phase change material is disposed on the non-woven material, the method further comprising:
mechanically connecting the first layer and third layer by needle felting the ballistic unit, thereby pulling portions of the non-woven third layer into the woven first layer perpendicular to the woven fabric and entangling the two layers.
